(19) United States
(12) Patent Application Publication
(10) Pub. No.: US 2019/0130392 A1
(43) Pub. Date: May 2, 2019

(54) AUTOMATIC GENERATION OF TAX INFORMATION FROM A DISTRIBUTED LEDGER

(71) Applicant: Tax Token LLC, Harrisonburg, PA (US)

(72) Inventor: Gaurav D. Kale, Harrisonburg, PA (US)

(21) Appl. No.: 16/171,252

(22) Filed: Oct. 25, 2018

Related U.S. Application Data
(60) Provisional application No. 62/577,557, filed on Oct. 26, 2017.

(51) Int. Cl. G06Q 20/36; G06Q 20/40; H04L 9/06

(52) U.S. Cl. CPC G06Q 20/3678; G06Q 2220/00; H04L 9/0637; G06Q 20/401

(57) ABSTRACT

A method is provided for determining a cost basis for transactions in a cryptocurrency recorded in a blockchain. The method accesses an identifier of transactions recorded in the blockchain. The method collects transactions recorded in the blockchain that are associated with the identifier. The method, for each purchase transaction, identifies a purchase price associated with the purchase transaction. The method for each sale transaction, identifies a sale price associated with the sale transaction. The method pairs sale transactions with one or more purchase transactions. For each sales transaction, the method generates the cost basis for the sales transaction based on the sale price and the sale cryptocurrency amount of the sale transaction and the purchase price and the purchase cryptocurrency amount of the purchase transaction.

### CROSS-REFERENCE TO RELATED APPLICATION(S)

This application claims the benefit of U.S. Provisional Patent Application No. 62/577,557, filed Oct. 26, 2017. The foregoing application is incorporated herein by reference in its entirety.

### BACKGROUND

The bitcoin system was developed to allow electronic cash to be transferred directly from one party to another without going through a financial institution, as described in the white paper entitled “Bitcoin: A Peer-to-Peer Electronic Cash System” by Satoshi Nakamoto. A bitcoin is an electronic coin (also referred to as a “cryptocurrency”) that is represented by a chain of transactions that transfers ownership from one party to another party. To transfer ownership of a bitcoin, a new transaction is generated and added to a stack of transactions in a block. The new transaction, which includes the public key of the new owner, is digitally signed by the owner with the owner's private key to transfer ownership to the new owner as represented by the new owner public key. Once the block is full, the block is “capped” with a block header that is a hash digest of all the transaction identifiers within the block. The block header is recorded as the first transaction in the next block in the chain, creating a mathematical hierarchy called a “blockchain.” To verify the current owner, the blockchain of transactions can be followed to verify each transaction from the first transaction to the last transaction. The new owner need only have the private key that matches the public key of the transaction that transferred the bitcoin. The blockchain creates a mathematical proof of ownership in an entity represented by a security identity (e.g., a public key), which in the case of the bitcoin system is pseudo-anonymous.

To ensure that a previous owner of a bitcoin did not double-spend the bitcoin (i.e., transfer ownership of the same bitcoin to two parties), the bitcoin system maintains a distributed ledger of transactions. With the distributed ledger, a ledger of all the transactions for a bitcoin is stored redundantly at multiple nodes (i.e., computers) of a blockchain network. The ledger at each node is stored as a blockchain. In a blockchain, the transactions are stored in the order that the transactions are received by the nodes. Each node in the blockchain network has a complete replica of the entire blockchain. The bitcoin system also implements techniques to ensure that each node will store the identical blockchain, even though nodes may receive transactions in different orderings. To verify that the transactions in a ledger stored at a node are correct, the blocks in the blockchain can be accessed from oldest to newest, generating a new hash of the block and comparing the new hash to the hash generated when the block was created. If the hashes are the same, then the transactions in the block are verified. The bitcoin system also implements techniques to ensure that it would be infeasible to change a transaction and regenerate the blockchain by employing a computationally expensive technique to generate a nonce that is added to the block when it is created. The process of finding a nonce that results in a hash of a block with certain characteristics (e.g., number of leading zeros) is referred to as mining. A bitcoin ledger is sometimes referred to as an Unspent Transaction Output (“UTXO”) set because it tracks the output of all transactions that have not yet been spent.

Although the bitcoin system has been very successful, it is limited to transactions in bitcoins or other cryptocurrencies. Efforts are currently underway to use blockchains to support transactions of any type, such as those relating to the sale of vehicles, sale of financial derivatives, sale of stock, payments on contracts, and so on. Such transactions use identity tokens, which are also referred to as digital bearer bonds, to uniquely identify something that can be owned or can own other things. An identity token for a physical or digital asset is generated using a cryptographic one-way hash of information that uniquely identifies the asset. Tokens also have an owner that uses an additional public/private key pair. The owner public key is set as the token owner identity and when performing actions against tokens, ownership proof is established by providing a signature generated by the owner private key and validated against the public key listed as the owner of the token. A person can be uniquely identified, for example, using a combination of a user name, social security number, and biometric (e.g., fingerprint). A product (e.g., refrigerator) can be uniquely identified, for example, using the name of its manufacturer and its serial number. The identity tokens for each would be a cryptographic one-way hash of such combinations. The identity token for an entity (e.g., person or company) may be the public key of a public/private key pair, where the private key is held by the entity. Identity tokens can be used to identify people, institutions, commodities, contracts, computer code, equities, derivatives, bonds, insurance, loans, documents, and so on. Identity tokens can also be used to identify collections of assets. An identity token for a collection may be a cryptographic one-way hash of the digital tokens of the assets in the collection. The creation of an identity token for an asset in a blockchain establishes provenance of the asset, and the identity token can be used in transactions (e.g., buying, selling, insuring) of the asset stored in a blockchain, creating a full audit trail of the transactions.

To record a simple transaction in a blockchain, each party and asset involved with the transaction needs an account that is identified by a digital token. For example, when one person wants to transfer a car to another person, the current owner and next owner create accounts, and the current owner also creates an account that is uniquely identified by its vehicle identification number. The account for the car identifies the current owner. The current owner creates a transaction against the account for the car that indicates that the transaction is a transfer of ownership transfer, indicates the public keys (i.e., identity tokens) of the current owner and the next owner, and indicates the identity token of the car. The transaction is signed by the private key of the current owner and the transaction is evidence that the next owner is now the current owner.

To enable more complex transactions than bitcoin can support, some systems use “smart contracts.” A smart contract is computer code that implements transactions of a contract. The computer code may be executed in a secure platform (e.g., an Ethereum platform, which provides a virtual machine) that supports recording transactions in blockchains. In addition, the smart contract itself is recorded as a transaction in the blockchain using an identity token that is a hash (i.e., identity token) of the computer code so that the computer code that is executed can be authenticated. When deployed, a constructor of the smart contract executes, initializing the smart contract and its state. The state of a smart contract is stored persistently in the blockchain. When a transaction is recorded against a smart contract, a message is sent to the smart contract, and the computer code of the smart contract executes to implement the transaction (e.g., debit a certain amount from the balance of an account). The computer code ensures that all the terms of the contract are complied with before the transaction is recorded in the blockchain. For example, a smart contract may support the sale of an asset. The inputs to a smart contract to sell a car may be the identity tokens of the seller, the buyer, and the car and the sale price in U.S. dollars. The computer code ensures that the seller is the current owner of the car and that the buyer has sufficient funds in their account. The computer code then records a transaction that transfers the ownership of the car to the buyer and a transaction that transfers the sale price from the buyer's account to the seller's account. If the seller's account is in U.S. dollars and the buyer's account is Canadian dollars, the computer code may retrieve a currency exchange rate, determine how many Canadian dollars the seller's account should be debited, and record the exchange rate. If either transaction is not successful, neither transaction is recorded.

When a message is sent to a smart contract to record a transaction, the message is sent to each node that maintains a replica of the blockchain. Each node executes the computer code of the smart contract to implement the transaction. For example, if 100 nodes each maintain a replica of a blockchain, then the computer code executes at each of the 100 nodes. When a node completes execution of the computer code, the result of the transaction is recorded in the blockchain. The nodes employ a consensus algorithm to decide on which transactions to keep and which transactions to discard. Although the execution of the computer code at each node helps ensure the authenticity of the blockchain, it requires large amounts of computer resources to support such redundant execution of computer code.

The term “contract” has been used to describe the computer code of a contract under the UTXO model of bitcoin and the computer code of the “smart contracts” model of the Ethereum platform. The “contracts” under these models are, however, different. In the UTXO model, the distributed ledger is a set of immutable rows keyed by (hash: output index) values. The “hash” is a hash of the transaction that generated the output represented by the row, and the “output index” identifies which one of the possibly many outputs of the transaction that the row represents. A UTXO contract is deterministic and performs no processing other than validating the inputs to the transaction. In the “smart contract” model, the computer code of the smart contract is an instantiation of the computer code that is maintained by every node that stores the block chain. A “smart contract” can perform virtually any type of processing such as receiving messages, sending messages, accessing external databases, and so on.

To facilitate the transfer of electronic coins (e.g., bitcoins and ether), wallets and exchanges have been developed. A wallet is a software system that stores the public/private key pair of a user and allows a user to conduct transactions with electronic coins of a blockchain. A wallet interfaces with a blockchain to identify transactions associated with the public key (or other identifier derived from the public key) and amount of electronic coins associated with the public key. A wallet may locally store all or part of a blockchain or may interface with a node that stores the entire blockchain.

An exchange (e.g., Coinbase) is a system (e.g., web site) that allows the exchange of electronic coins to fiat currency and vice versa or the exchange of one type of cryptocurrency to another (e.g., bitcoin to ether). An exchange maintains accounts for it users and may have maintain the wallets of its users or may interface with those wallets maintained by its users. An exchange matches sellers and buyers of cryptocurrencies and fiat currencies. Users register with an exchange and may be required to disclose their identity using a “Know Your Customer” (“KYC”) process to comply with the regulations (e.g., anti-laundering regulations) of various jurisdictions. As part of the KYC process, a user may be required to provide their phone number or other type of account identifier from which the actual identity of the user can be determined. The exchange may employ a verification process to ensure that the user has access to the account. For example, the exchange may send an electronic mail message with a confirmation code to the electronic mail address provided by the user and request the user to provide the confirmation code to the exchange as evidence that the user has access electronic mail messages sent to that electronic mail address. Although an exchange may provide web pages for exchanging currencies, an exchange may also provide an application programming interface (“API”) through which applications can accesses the services of the exchange. For example, an application may automatically submit transactions via the API to an exchange when a specified exchange rate has been reached. A user of such an application can delegate permission to the application to access the user's account to the application.

### BRIEF DESCRIPTION OF THE DRAWINGS

FIG. 1 is a flow diagram that illustrates the processing of a generate tax information component of the DLT system in some embodiments.

FIG. 2 is a block diagram that illustrates components of the DLT system and systems with which the DLT system interfaces.

FIG. 3 is a flow diagram that illustrates the processing of a register exchange user component of the DLT system in some embodiments.

FIG. 4 is a flow diagram that illustrates the processing of a retrieve exchange transactions component of the DLT system in some embodiments.

FIG. 5 is a flow diagram that illustrates the processing of a register wallet user component of the DLT system in some embodiments.

FIG. 6 is a flow diagram that illustrates the processing of an initiate blockchain scan component of the DLT system in some embodiments.

FIG. 7 is a flow diagram that illustrates the processing of a scan blockchain component in some embodiments.

FIG. 8 is a flow diagram that illustrates a process transaction component of the DLT system in some embodiments.

FIG. 9 is a flow diagram that illustrates the processing of a calculate gain/loss component of the DLT system in some embodiments.

### DETAILED DESCRIPTION

A method and system are provided for generating tax information relating to transactions stored in a distributed ledger. In some embodiments, a distributed ledger tax (“DLT”) system identifies transactions recorded in the distributed ledger that have tax implications. For example, the distributed ledger may be a blockchain that records transactions relating to the transfer of a cryptocurrency (e.g., bitcoins or ether) from one entity to another entity. An entity may be a person, a corporation, a charity, a trust, or any other organization associated with tax information. Each entity may be identified by its address, public key, wallet, and so on. A distributed ledger (e.g., Ethereum blockchain) may also support the recording of diverse transactions relating to more than just cryptocurrencies. For example, the transactions may relate to the purchase and sale of assets (e.g., property and fine art), income received by an entity, interest paid by an entity, a charitable contribution made by an entity, taxes paid, and so on. If the transactions relate to the transfer of a cryptocurrency, the DLT system may interface with an exchange system to collect transactions for the entity. When the distributed ledger stores only cryptocurrency transactions or when it stores diverse transactions, the DLT system may directly scan at least portions of the distributed ledger at various times to collect the transactions relating to the entities whose tax information is to be generated.

In some embodiments, after collecting the transactions, the DLT system generates tax information for reporting, for example, to a tax authority (e.g., Internal Revenue Service of the United States, or a local state, county, or city tax authority). When generating tax information relating to the purchase and sale of a cryptocurrency, the DLT system determines the amount of the cryptocurrency purchased or sold and the purchase or sale price of each transaction. The purchase price and sale price may be represented in a fiat currency (e.g., U.S. Dollar, Euros, and Chinese Yuan). The distributed ledger may record the purchase amount or sale amount of the cryptocurrency, but not the purchase price or sale price. In such a case, the DLT system may retrieve the purchase and sale prices from an exchange system that handled the recording of the transactions in the distributed ledger, may prompt the entity to provide the purchase or sale prices for the transactions, may access a mapping of transactions to purchase and sale prices, and so on. After collecting the transactions, the DLT system determines the cost basis for each sale transaction as prescribed by a tax authority. For example, the DLT system may pair a sale transaction with a purchase transaction that has not already been paired. The DLT system may determine the cost basis for a sale transaction based on the purchase price per cryptocurrency of the purchase transaction and amount of cryptocurrency of the sale transaction. The DLT system may also determine a capital gain amount (a loss may be represented as a negative gain) for the sale transaction based on the cost basis and sale price of the sale transaction. The DLT system may also determine whether the capital gain amount represents a long-term capital gain or a short-term capital gain based on the time between the purchase transaction and the sale transaction. For example, if the time is less than six months, then the capital gain amount may be considered to be a short-term capital gain. The DLT system may be used to generate tax information for any assets (e.g., non-cryptocurrency assets) whose purchase transactions and sales transaction are recorded in the distributed ledger.

In some embodiments, the DLT system generates tax information for diverse transactions such as payment of property taxes, mortgage payments, income payments, capital expenditures, business expenditures, dividend income, stock purchases and sales, and so on. To help ensure that the tax information is as complete as possible, various organizations may record transactions in the distributed ledger. For example, a credit card company may record a transaction for each credit card charge, a bill payer system may record a transaction for each payment, a mortgage company may record a transaction for each interest payment, and so on. In such a case, the distributed ledger may include multiple transactions relating to single underlying transaction. For example, a bill payer system may record a transaction relating to payment for property tax, and the corresponding tax authority may also record a transaction relating to payment of the property tax. In such a case, the DLT system may perform a duplication identification process to identify transactions representing the same underlying transaction.

In some embodiments, the DLT system may include different components for generating tax information for different types of transactions. For example, the DLT system may include a capital gains component for determining capital gains, a charitable contribution component for determining charitable contributions, a personal deduction component for determining personal deductions, and so on. The DLT system may also have different components for various tax authorities or jurisdictions. For example, the DLT system may have separate capital gains components for the United States, for New York State, and for the Federal Republic of Germany.

In some embodiments, the DLT system may auto-populate portions of a tax form (e.g., 1040 form for the U.S.) based on the generated tax information or output the tax information for manual input into a tax form. Alternatively, the DLT system may interface with a tax software system (e.g., TurboTax) and provide the tax information to the tax software system for use in generating tax forms.

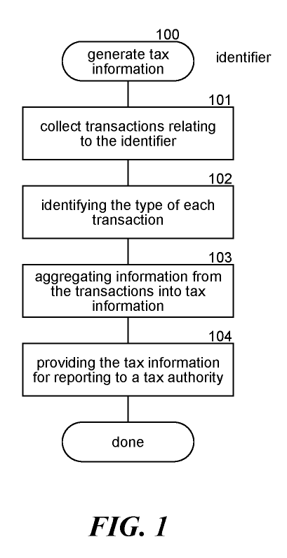

FIG. 1 is a flow diagram that illustrates the processing of a generate tax information component of the DLT system in some embodiments. A generate tax information component 100 is invoked passing an indication of an identifier of an entity and generates tax information for that entity. In block 101, the component collects transactions recorded in the distributed ledger that relate to the entity. The component may retrieve the transactions from an exchange system that records transactions in the distributed ledger or by scanning the distributed ledger. In block 102, the component identifies the types of transactions such as purchase transactions, sale transactions, payment transactions, and so on. In block 103, the component aggregates information from the transactions into tax information. For example, the component may determine the cost basis for sale transactions and determine the capital gain amounts. In block 104, the component provides the tax information for reporting to the tax authority and then completes. For example, the component may populate a tax form based on the tax information, send the tax information to a tax software system, send the information to the tax authority, and so on.

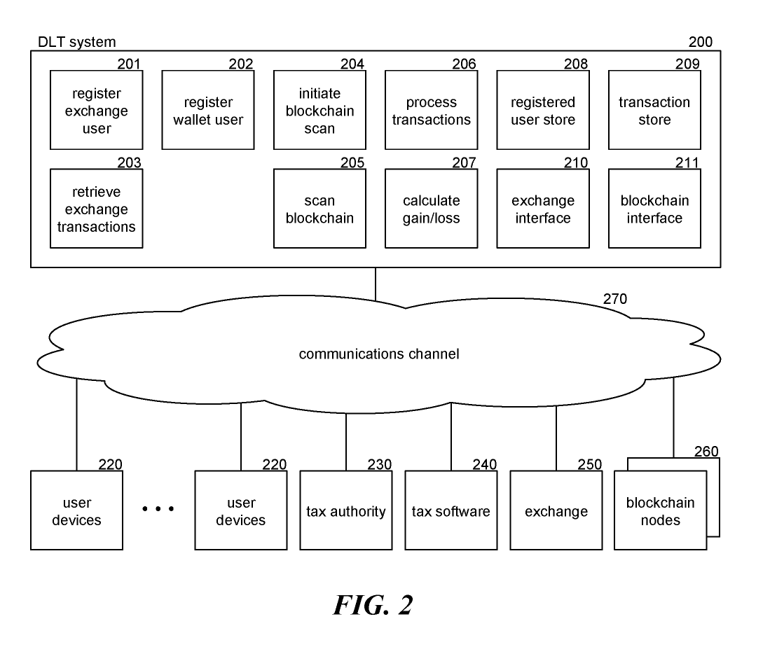

FIG. 2 is a block diagram that illustrates components of the DLT system and systems with which the DLT system interfaces. The DLT system 200 may be connected to user devices 220, a tax authority system 230, a tax software system 240, an exchange system 240, and blockchain nodes 260 of a distributed ledger via a communications channel 270. The DLT system may include a register exchange user component 201, a register wallet user component 202, a retrieve exchange transaction component 203, an initiate blockchain scan component 204, a scan blockchain component 205, a process transaction component 206, and a calculate cost gain/loss component 207. The DLT system also includes a registered user store 208, a transaction store 209, an exchange interface 210, and a blockchain interface 211. The register exchange user component supports the registration of users or other entities who are registered with an exchange system. The register wallet user component supports the registration of users or other entities who have wallets associated with the distributed ledger. The retrieve exchange transaction component interacts with the exchange system to retrieve the transactions associated with an entity registered with the exchange. The initiate blockchain scan component and the scan blockchain component scan the distributed ledger based on the wallets associated with the entities to identify transactions for the entities. The process transaction component and the calculate gain/loss component perform the generating of tax information from the collected transactions. The registered user store stores information on the registered entities, and a transaction store stores the collected transactions. The registered user store may also store the tax information generated for the entities. The exchange interface and the blockchain interface provide an interface with the exchange system and the blockchain nodes, respectively.

The computing systems (e.g., nodes) on which the DLT system may be implemented may include a central processing unit, input devices, output devices (e.g., display devices and speakers), storage devices (e.g., memory and disk drives), network interfaces, graphics processing units, cellular radio link interfaces, global positioning system devices, and so on. The input devices may include keyboards, pointing devices, touch screens, gesture recognition devices (e.g., for air gestures), head and eye tracking devices, microphones for voice recognition, and so on. The computing systems may include desktop computers, laptops, tablets, e-readers, personal digital assistants, smartphones, gaming devices, servers, and so on. The computing systems may access computer-readable media that include computer-readable storage media and data transmission media. The computer-readable storage media are tangible storage means that do not include a transitory, propagating signal. Examples of computer-readable storage media include memory such as primary memory, cache memory, and secondary memory (e.g., DVD) and other storage. The computer-readable storage media may have recorded on it or may be encoded with computer-executable instructions or logic that implements the DLT system. The data transmission media is used for transmitting data via transitory, propagating signals or carrier waves (e.g., electromagnetism) via a wired or wireless connection. The computing systems may include a secure cryptoprocessor as part of a central processing unit for generating and securely storing keys and for encrypting and decrypting data using the keys.

The DLT system may be described in the general context of computer-executable instructions, such as program modules and components, executed by one or more computers, processors, or other devices. Generally, program modules or components include routines, programs, objects, data structures, and so on that perform particular tasks or implement particular data types. Typically, the functionality of the program modules may be combined or distributed as desired in various examples. Aspects of the DLT system may be implemented in hardware using, for example, an application-specific integrated circuit (ASIC) or field programmable gate array (“FPGA”).

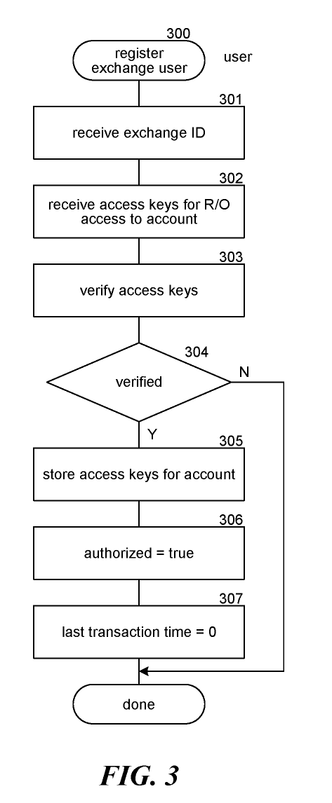

FIG. 3 is a flow diagram that illustrates the processing of a register exchange user component of the DLT system in some embodiments. A register exchange user component 300 is invoked passing an indication of a user and registers the user with the DLT system. In block 301, the component receives an indication of the exchange system with which the user is registered. In block 302, the component receives access keys for read-only access to the account of the user with the exchange system. In block 303, the component accesses the exchange system to verify the access keys. In decision block 304, if the access keys have been verified, then the component continues at block 305, else the component completes. In block 305, the component stores the access keys for the account in the registered user store. In block 306, the component sets an authorized flag to true for the user. The DLT system may allow the user to change the authorized flag to revoke authorization to access the exchange. In block 307, the component sets the last transaction time to indicate the time of the last transaction collected for the user. The component then completes.

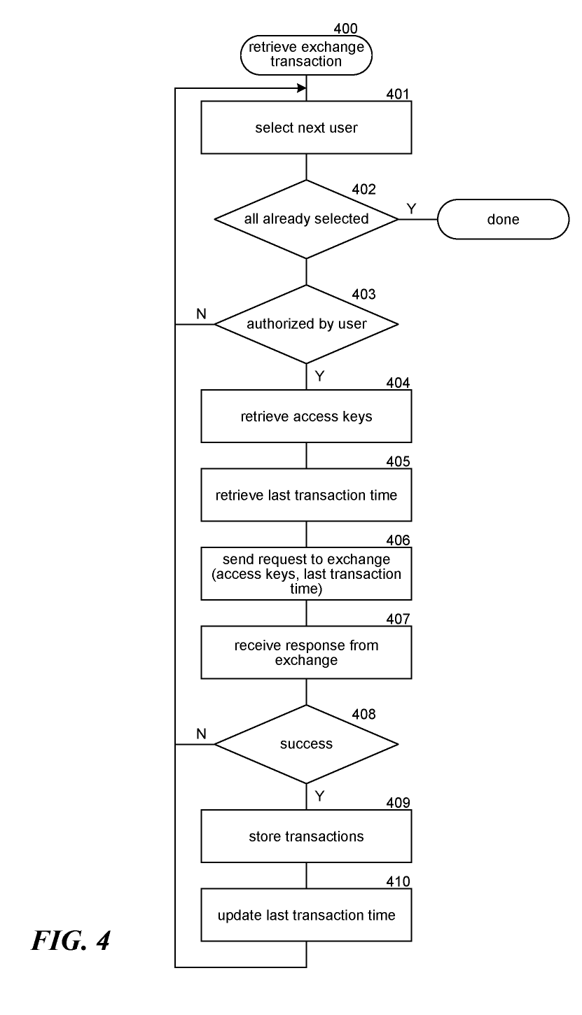

FIG. 4 is a flow diagram that illustrates the processing of a retrieve exchange transactions component of the DLT system in some embodiments. A retrieve exchange transactions component 400 is invoked to retrieve transactions of users from an exchange. In blocks 401-410, the component loops selecting each user and retrieving the transactions for each user. In block 401, the component selects the next user. In decision block 402, if all the users have already been selected, then the component completes, else the component continues at block 403. In decision block 403, if the authorized flag is true, then the component continues at block 404, else the component loops to block 401 to select the next user. In block 404, the component retrieves the access keys for the selected user. In block 405, the component retrieves the last transaction time for the selected user. In block 406, the component sends a request to the exchange system passing an indication of the access keys and the last transaction time. In block 407, the component receives the response from the exchange. In decision block 408, if the request was successful, then the component continues at block 409, else the component loops to block 401 to select the next user. A request may not be successful, for example, if the user has de-registered from the exchange. In block 409, the component stores in the transaction store the transactions received in the response. In block 410, the component updates the last transaction time to the time of the last transaction received in the response and then loops to block 401 to select the next user.

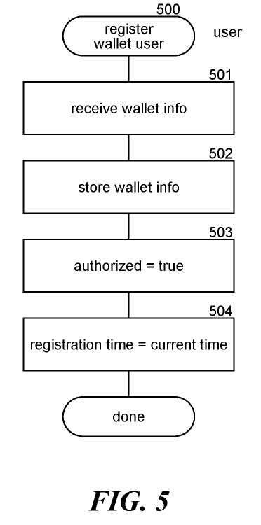

FIG. 5 is a flow diagram that illustrates the processing of a register wallet user component of the DLT system in some embodiments. A register wallet user component 500 is invoked passing an indication of the user to register with the DLT system the wallet of that user. In block 501, the component receives wallet information for the user. In block 502, the component stores the wallet information in the registered user store. In block 503, the component sets the authorized flag to true for the user, which the user can change. In block 504, the component sets the registration time to the current time and then completes. The registration time indicates the time that the user registered with the DLT system for use in determining whether to include the user in a full scan as discussed below.

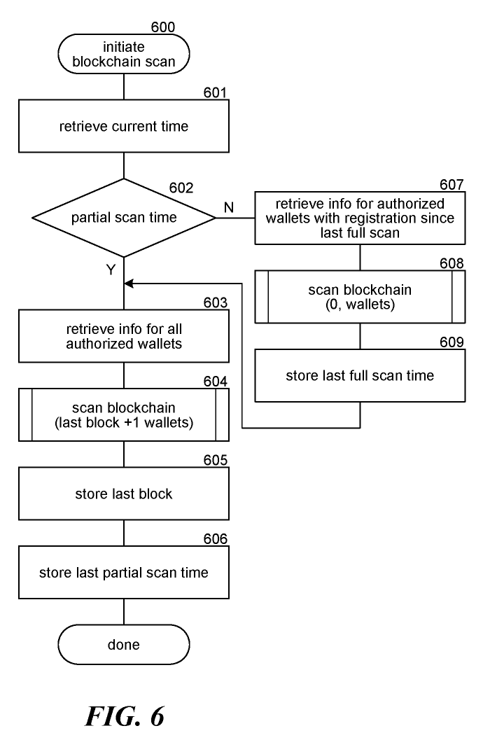

FIG. 6 is a flow diagram that illustrates the processing of an initiate blockchain scan component of the DLT system in some embodiments. An initiate block scan component 600 is invoked to initiate a scan of a distributed ledger. The DLT system may include a similar component to perform a scan of a distributed ledger that is not a blockchain. The DLT system may perform two different scans of a blockchain: a partial scan and a full scan. With a full scan, the DLT system scans from the first block the blockchain to the last block in the blockchain. Because such a full scan can be time-consuming, the DLT system may perform a full scan only infrequently (e.g., once a day). With a partial scan, the DLT system more frequently (e.g., 30 minutes) scans the blocks of the blockchain that have been added since the last partial scan or full scan. A full scan collects all the transactions for newly registered entities. A partial scan collects the transactions for the registered users since the last partial scan or full scan. The component may be invoked at a partial scan time interval and determine whether it is time for a partial or full scan. In block 601, the component retrieves the current time. In decision block 602, if the current time indicates that it is time for a partial scan, then the component continues at block 603, else the component continues at block 607. In block 603, the component retrieves information for the wallets of the entities who have authorized the collecting of their transactions. In block 604, the component invokes a scan blockchain component passing an indication of the starting block to scan, which is the block after the last block scanned in the last partial scan, and an indication of the wallets of the entities. The scan block component performs a scan from the starting block to the current last block in the blockchain for transactions involving the entities and stores the transactions in the transaction store. In block 605, the component stores an indication of the last block scanned. In block 606, the component stores the time of the last partial scan. In block 607, the component retrieves information for the authorized wallets that have registered since the last full scan. In block 608, the component invokes the scan blockchain component passing an indication of the starting block of the blockchain and the wallets of the newly registered user. The scan blockchain component retrieves the transactions in the blockchain associated with the newly registered users. In block 609, the component stores the last full scan time and then continues at block 603 to perform a partial scan for all authorized wallets.

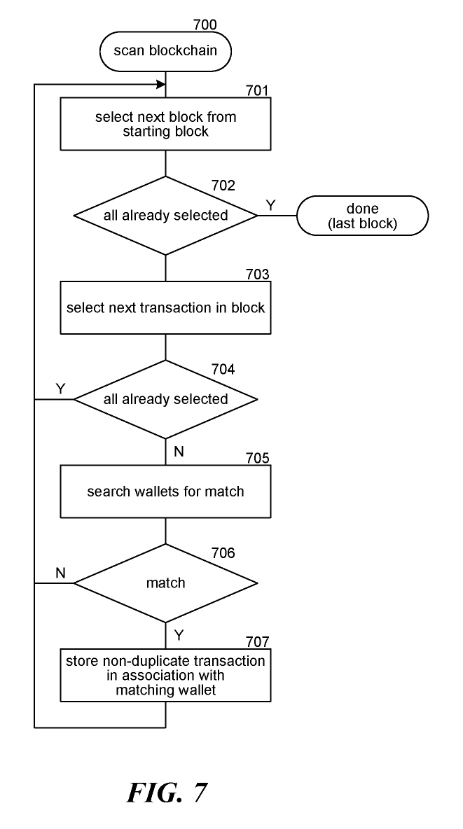

FIG. 7 is a flow diagram that illustrates the processing of a scan blockchain component in some embodiments. A scan blockchain component 700 is invoked to scan a blockchain passing an indication of the starting block for the scan and the wallets of the entities whose transactions should be collected. The scan blockchain component scans the blockchain from the starting block to the current last block of the blockchain for the entities represented by the wallets and stores the transactions in the transaction store. In block 701, the component selects the next block starting with the starting block. In decision block 702, if all the blocks after the starting block have already been selected, then the component returns with an indication of the last block processed, else the component continues at block 703. In block 703, the component selects the next transaction in the selected block. In decision block 704, if all the transactions in the selected block have already been selected, then the component loops to block 701 to select the next block in the blockchain, else the component continues at block 705. In block 705, the component searches the wallets to determine whether the identifier associated with a wallet matches the identifier (or identifiers as a transaction may involve the sale by one registered entity and purchase by another registered entity) of the selected transaction. In decision block 706, if there is a match, then the component continues at block 707, else the component loops to block 701 to select the next block. In block 707, the component stores the selected transaction in the transaction store associated with the matching wallet(s) if the transaction is not already stored in the transaction store for the matching wallet. A transaction may have already been stored in the transaction store if a full scan has been completed followed by a partial scan that again identifies the transactions for newly registered entities. The component then loops to block 701 to select the next block.

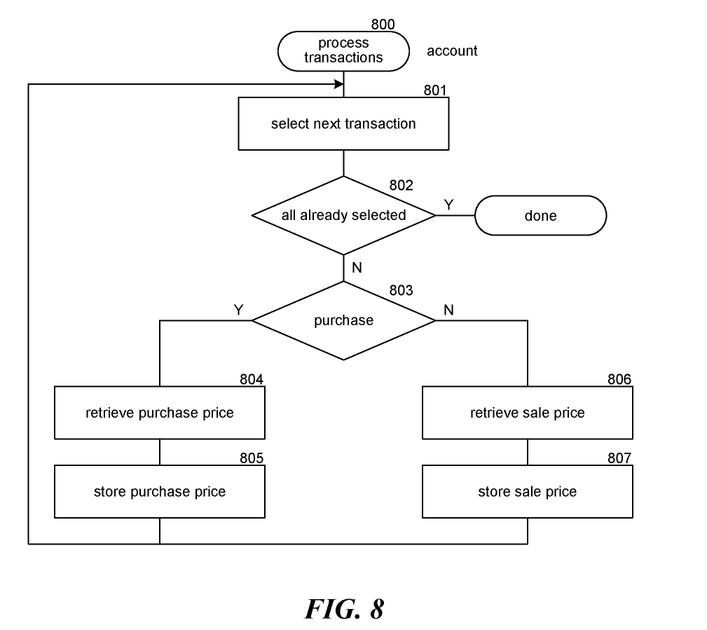

FIG. 8 is a flow diagram that illustrates a process transaction component of the DLT system in some embodiments. A process transaction component 800 is invoked passing indication of an entity and determines the purchase and sale price of the transactions relating to a cryptocurrency. In block 801, the component selects the next transaction in the transaction store for the entity. In decision block 802, if all the transactions for the entity have already been selected, then the component completes, else the component continues at block 803. In decision block 803, if the selected transaction is a purchase transaction, then the component continues at block 804, else the component continues at block 806. In block 804, the component retrieves the purchase price associated with the purchase transaction. In block 805, the component stores the purchase price in the transaction store and then loops to block 801 to select the next transaction. In block 806, the component retrieves the sale price for the selected transaction. In block 807, the component stores the sale price in the transaction store and then loops to block 801 to select the next transaction. The component may retrieve the purchase price and sale price from the exchange system that recorded the transaction or the transactions, prompt a user to enter the price, and so on.

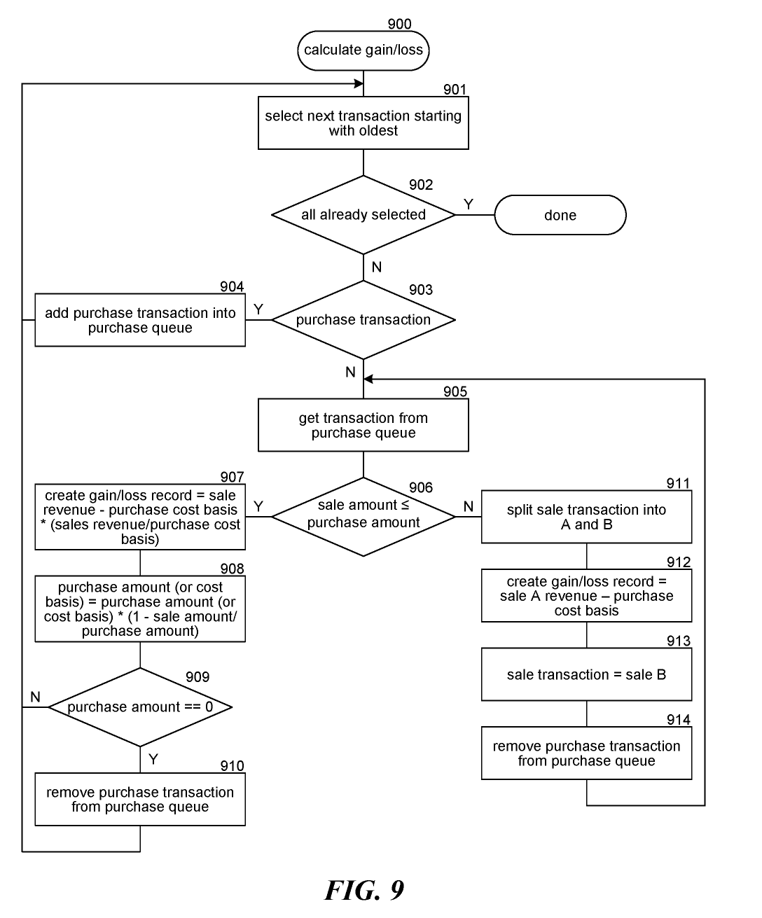

FIG. 9 is a flow diagram that illustrates the processing of a calculate gain/loss component of the DLT system in some embodiments. A calculate gain/loss component 900 is invoked to determine the gain or loss for sale transactions of an entity. In block 901, the component selects the next transaction starting with the oldest. In decision block 902, if all the sales transactions have already been selected, then the component completes, else the component continues at block 903. In decision block 903, if the selected transaction is a purchase transaction, then the component continues at block 904, else the component continues at block 905. In block 904, the component adds the selected purchase transaction to a purchase queue and then loops to block 901 to select the next transaction. The purchase queue will contain purchase transactions that have not yet been paired with a sale transaction for determining the gain/loss based on the purchase cost basis of the purchase transaction and the sale revenue of the sale transaction. In block 905, the selected transaction is a sale transaction, and the component selects (without removing) the purchase transaction from the purchase queue. In decision block 906, if the sale amount of the selected sale transaction is less than or equal to the purchase amount of the purchase transaction, then the component continues at block 907, else the component continues at block 911. The purchase/sale amount of a purchase/sale transaction is the quantity of the asset (e.g., 5 Bitcoins) purchased/sold by the transaction. In block 907, the component creates a gain/loss record with a value set to the sale revenue of the sale transaction minus the purchase cost basis of the purchase transaction times the ratio of the sale revenue to the purchase cost basis. The ratio is factored in to account for when the sale amount is less than the purchase amount—that is the purchase amount is not fully paired with the sale amount. The sale revenue is the total sale price minus any fees for the sale amount of the sale transaction, and the purchase cost basis is the total purchase price plus any fees for the purchase amount of the purchase transaction. In block 908, the component adjusts the selected purchase transaction by adjusting the purchase amount and purchase cost basis of the purchase transaction to remove the purchase amount and purchase cost basis portion paired with the sale amount and sale revenue of the sale transaction. The component adjusts each by multiplying by one minus the ratio of the sale amount to the purchase amount. In decision block 909, if the purchase amount is zero, then all the purchase amount was paired with all the sale amount and the component continues at block 910, else the component leaves the adjusted purchase transaction at the top of the purchase queue to be re-reselected in block 905 and loops to block 901 to select the next transaction. In block 910, the component removes the selected purchase transaction from the top of the purchase queue and loops to block 901 to select the next transaction. In block 911, since the sale amount is greater than the purchase amount, the component splits the sale transaction to fully pair the purchase amount of the purchase transaction with a split portion of the sale amount. The component splits the sale transaction into an A portion with a sale amount A and a sale revenue A, and a B portion with a sale amount B and a sale revenue B. The sale amount A and the sale revenue A are set to the sale amount and sale revenue, respectively, multiplied by the ratio of the purchase amount to the sale amount. The sale amount B and the sale revenue B are set to the sale amount and the sale revenue, respectively, multiplied by one minus the ratio of the purchase amount to the sale amount. In block 912, the component creates a gain/loss record with a value set to the sale revenue A minus the purchase cost basis of the selected purchase transaction. In block 913, the component sets the sale amount and the sale revenue of the sale transaction to the sale amount B and the sale revenue B, respectively. In block 914, the component removes the selected purchase transaction from the top of the purchase queue and loops to block 905 to select the next purchase transaction to pair with the remaining B portion of the split sale transaction.

The following paragraphs describe various embodiments of aspects of the DLT system. An implementation of the DLT may employ any combination of the embodiments.

In some embodiments, a method performed by one or more computing systems is provided for determining a cost basis for transactions in a cryptocurrency recorded in a blockchain. The method accesses an identifier of transactions recorded in the blockchain. The transactions include purchase transactions and sale transactions. Each purchase transaction has a purchase cryptocurrency amount, and each sale transaction has a sale cryptocurrency amount. The method collects transactions recorded in the blockchain that are associated with the identifier. The method, for each purchase transaction, identifies a purchase price associated with the purchase transaction. The method for each sale transaction, identifies a sale price associated with the sale transaction. The method pairs sale transactions with one or more purchase transactions. For each sales transaction, the method generates the cost basis for the sales transaction based on the sale price and the sale cryptocurrency amount of the sale transaction and the purchase price and the purchase cryptocurrency amount of the purchase transaction. In some embodiments, the method auto-populates a tax form based on the generated cost bases for the sale transactions. In some embodiments, the method collects deduction information from a financial system and auto-populating the tax form based on the collected deduction information. In some embodiments, the method provides the generated cost bases to a tax system for generating a tax form. In some embodiments, the collecting of the transactions includes accessing an exchange system to retrieve the transaction conducted via the exchange. In some embodiments, the collecting is performed at various times to collect the transactions conducted via the exchange since the last collecting of transactions associated with the identifier. In some embodiments, the collecting of the transactions includes scanning the blockchain to identify transactions associated with the identifier. In some embodiments, the blockchain includes blocks and the scanning is performed at various times starting from a block after the last block of a previous scan. In some embodiments, the scanning is performed at times less frequent than the various times starting from a first block of the blockchain. In some embodiments, the accessing includes accessing multiple identifiers of the transactions and the scanning is performed to collect transactions for the multiple identifiers. In some embodiments, the scanning performed at times less frequent includes scanning for only transactions associated with identifiers that were not collected on a previous scan. In some embodiments, the identifying of the price associated with a transaction includes receiving the price from a user. In some embodiments, the identifying of the price associated with a transaction includes receiving the price from an exchange system.

In some embodiments, a method is provided performed by one or more computing systems for identifying transactions recorded in a distributed ledger. The method accesses an identifier of an entity. The method collects transactions recorded in the distributed ledger that are associated with the identifier and that have tax implications. The method aggregates an income amount based on payment amounts of transactions relating to income received by the entity. The method, for each transaction relating to sale of an asset, calculates a cost basis for the sale based on sale price of the asset and purchase price of the asset as indicated by a transaction relating to the purchase of the asset. The method also provides the aggregated income amount and calculated cost bases for reporting to a tax authority. In some embodiments, the method aggregates interest payment amounts of transactions related to interest payments and provides the aggregated interest payment amount for reporting to the tax authority. In some embodiments, the method aggregates tax payment amounts of transactions related to tax payments and provides the aggregated tax payment amount for reporting to the tax authority. In some embodiments, the method aggregates charitable contribution amounts of transactions related to charitable contributions and provides the aggregated charitable contribution amount for reporting to the tax authority. In some embodiments, the providing sends that aggregated income amount and calculated cost bases to the tax authority. In some embodiments, the providing auto-populates a tax form.

In some embodiments, a computing system comprising one or more computer-readable storage mediums storing computer-executable instructions and one or more processor for executing the computer-executable instructions stored in the one or more computer-readable storage mediums. In some embodiments, instructions control the computing system to collect transactions, recorded in a blockchain, that are identified by an identifier associated with an entity. The transactions relate to purchase and sale of an asset. The instructions further control the computing system to, for each transaction relating to sale of an asset, generate a cost basis for the sale based on transactions relating to purchase of the asset. The instructions control the computing system to provide the cost bases for reporting to a tax authority.

Although the subject matter has been described in language specific to structural features and/or acts, it is to be understood that the subject matter defined in the appended claims is not necessarily limited to the specific features or acts described above. Rather, the specific features and acts described above are disclosed as example forms of implementing the claims. Accordingly, the invention is not limited except as by the appended claims.

I/We claim:

1. A method performed by one or more computing systems for determining a cost basis for transactions in a cryptocurrency recorded in a blockchain, the method comprising:
accessing an identifier of transactions recorded in the blockchain, the transactions including purchase transactions and sale transactions, each purchase transaction having a purchase cryptocurrency amount and each sale transaction having a sale cryptocurrency amount;
collecting transactions recorded in the blockchain that are associated with the identifier;
for each purchase transaction, identifying a purchase price associated with the purchase transaction;
for each sale transaction, identifying a sale price associated with the sale transaction;
pairing sale transactions with one or more purchase transactions; and
for each sales transaction, generating the cost basis for the sales transaction based on the sale price and the sale cryptocurrency amount of the sale transaction and the purchase price and the purchase cryptocurrency amount of the purchase transaction.

2. The method of claim 1 further comprising auto-populating a tax form based on the generated cost bases for the sale transactions.

3. The method of claim 2 further comprising collecting deduction information from a financial system and auto-populating the tax form based on the collected deduction information.

4. The method of claim 1 further comprising providing the generated cost bases to a tax system for generating a tax form.

5. The method of claim 1 wherein the collecting of the transactions includes accessing an exchange system to retrieve the transaction conducted via the exchange.

6. The method of claim 5 wherein the collecting is performed at various times to collect the transactions conducted via the exchange since the last collecting of transactions associated with the identifier.

7. The method of claim 1 wherein the collecting of the transactions includes scanning the blockchain to identify transactions associated with the identifier.

8. The method of claim 7 wherein the blockchain includes blocks and the scanning is performed at various times starting from a block after the last block of a previous scan.

9. The method of claim 8 wherein the scanning is performed at times less frequent than the various times starting from a first block of the blockchain.

10. The method of claim 9 wherein the accessing includes accessing multiple identifiers of the transactions and the scanning is performed to collect transactions for the multiple identifiers.

11. The method of claim 10 wherein the scanning performed at times less frequent includes scanning for only transactions associated with identifiers that were not collected on a previous scan.

12. The method of claim 1 wherein the identifying of the price associated with a transaction includes receiving the price from a user.

13. The method of claim 1 wherein the identifying of the price associated with a transaction includes receiving the price from an exchange system.

14. A method performed by one or more computing systems for identifying transactions recorded in a distributed ledger, the method comprising:
accessing an identifier of an entity;
collecting transactions recorded in the distributed ledger that are associated with the identifier and that have tax implications;
aggregating an income amount based on payment amounts of transactions relating to income received by the entity;
for each transaction relating to sale of an asset, calculating a cost basis for the sale based on sale price of the asset and purchase price of the asset as indicated by a transaction relating to the purchase of the asset; and
providing the aggregated income amount and calculated cost bases for reporting to a tax authority.

15. The method of claim 14 further comprising aggregating interest payment amounts of transactions related to interest payments and providing the aggregated interest payment amount for reporting to the tax authority.

16. The method of claim 14 further comprising aggregating tax payment amounts of transactions related to tax payments and providing the aggregated tax payment amount for reporting to the tax authority.

17. The method of claim 14 further comprising aggregating charitable contribution amounts of transactions related to charitable contributions and providing the aggregated charitable contribution amount for reporting to the tax authority.

18. The method of claim 14 wherein the providing sends that aggregated income amount and calculated cost bases to the tax authority.

19. The method of claim 14 wherein the providing auto-populates a tax form.

20. A computing system comprising:
one or more computer-readable storage mediums storing computer-executable instructions that control the computing system to:
collect transactions, recorded in a blockchain, that are identified by an identifier associated with an entity, the transactions relating to purchase and sale of an asset;
for each transaction relating to sale of an asset, generating a cost basis for the sale based on transactions relating to purchase of the asset; and
providing the cost bases for reporting to a tax authority; and
one or more processor for executing the computer-executable instructions stored in the one or more computer-readable storage mediums.
